(19) United States
(12) Patent Application Publication
(10) Pub. No.: US 2025/0253513 A1
(43) Pub. Date: Aug. 7, 2025

(54) HIGH FREQUENCY TERMINATIONS IN ELECTRONIC CIRCUITS

(71) Applicant: The Curators of the University of Missouri, Columbia, MO (US)

(72) Inventors: Seyedmostafa Mousavi, Rolla, MO (US); Xiaoning Ye, Portland, OR (US); DongHyun Kim, Rolla, MO (US)

(73) Assignee: The Curators of the University of Missouri, Columbia, MO (US)

(21) Appl. No.: 19/047,402

(22) Filed: Feb. 6, 2025

Related U.S. Application Data
(60) Provisional application No. 63/550,829, filed on Feb. 7, 2024.

(51) Int. Cl. H01P 1/26; H01Q 17/00

(52) U.S. Cl. CPC H01P 1/268; H01Q 17/007

(57) ABSTRACT

A signal termination is used within an electronic circuit to terminate signals thereof. The electronic circuit comprises at least two or more layers spaced apart along a vertical axis of the electronic circuit. Furthermore, the electronic circuit comprises a conductor on each layer and a via structure extending along the vertical axis between at least two of the two or more layers and contacting the conductors of two layers, thereby defining a signal path between the layers. Moreover, a termination comprising an absorber sheet is installed on the electronic circuit by covering the via structure with the absorber sheet to absorb a signal traveling along the signal path, thereby terminating the signal at high frequencies.

### CROSS-REFERENCE TO RELATED APPLICATION

This application claims the benefit of U.S. Provisional Application No. 63/550,829, filed Feb. 7, 2024, the entire disclosure of which is incorporated herein by reference.

### GOVERNMENT LICENSE RIGHTS

This invention was made with government support under 00065550 and 00072099 awarded by the National Science Foundation. The government has certain rights in the invention.

### FIELD

This disclosure pertains to terminating signals within an electronic circuit.

### BACKGROUND

Signal termination is a critical aspect of electronic circuit design, especially in applications such as antennas, transceivers, and high-frequency electronics. Conventionally, 50 0 terminations are used to match impedance and reduce signal reflections in electronic circuits.

### SUMMARY

Aspects of the present disclosure permit an improved framework for terminating signals within an electronic circuit.

In one aspect, an electronic circuit comprises a plurality of layers, including an upper layer and one or more lower layers. The layers are spaced apart along a vertical axis of the electronic circuit. A conductor is between the upper layer and at least one of the lower layers. A via structure extends along the vertical axis between at least the upper layer and one lower layer and is configured to contact the conductor. The via structure and the conductor define a signal path between the layers. A termination on the via structure comprises an absorber sheet contacting the via structure on the upper layer. The absorber sheet is configured to absorb a signal traveling along the signal path when the absorber sheet contacts the via structure and the conductor.

In another aspect, a termination for terminating an electromagnetic signal traveling along a signal path of an electronic circuit comprises an absorber sheet configured to contact at least a portion of the signal path to be terminated. The absorber sheet comprises one or more absorber materials configured to absorb the electromagnetic signal when the absorber sheet contacts the portion of the signal path.

In another aspect, a method for terminating a signal in an electronic circuit assembly comprises covering a via structure in the electronic circuit assembly with an absorber sheet and applying pressure to the absorber sheet to create a contact to the via structure such that the absorber sheet absorbs the signal thereby terminating the signal. Terminating the signal does not include at least one of soldering or screwing an electrical load to the electronic circuit.

Other objects and features will be in part apparent and in part pointed out hereinafter.

### BRIEF DESCRIPTION OF THE DRAWINGS

FIG. 1 is a schematic diagram illustrating an electronic circuit with a termination according to an embodiment.

FIG. 2 is a graph illustrating example measurements of insertion loss with and without the absorber sheet according to an embodiment.

Corresponding reference characters indicate corresponding parts throughout the drawings.

### DETAILED DESCRIPTION

This disclosure generally pertains to systems and methods for terminating signals in electronic circuits. Signal terminations are critical in electronic circuit design to prevent signals of the electronic circuits from reflection. Conventional signal terminations generally comprise 50Ω loads that are soldered or screwed to components of an electronic circuit assembly, such as ends of wires, vias, and cables. The 50Ω loads are configured to match impedance of the components to minimize signal reflections and power losses. The inventors have recognized several difficulties with conventional signal terminations, one of which being that conventional signal terminations are not effective in terminating high-frequency signals. Furthermore, installing and uninstalling conventional and bulky signal terminations are time-consuming processes, as they require soldering and desoldering. As will be explained in further detail below, the signal termination of the present disclosure is easily installed, and effectively terminates radio frequency (RF) signals and microwave signals.

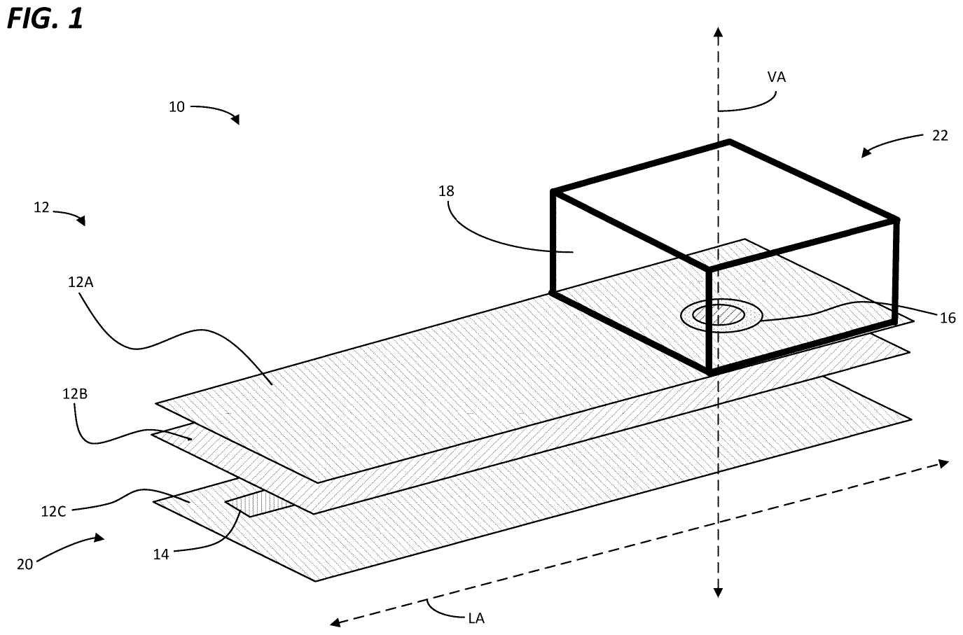

Referring now to FIG. 1, an exemplary embodiment of an electronic circuit assembly in accordance with the present disclosure is generally indicated at reference number 10. In an exemplary embodiment, the electronic circuit assembly 10 includes a printed circuit board on which a plurality of electronic components through which signals can flow are installed. The electronic circuit assembly 10 broadly comprises two or more layers 12 spaced apart along a vertical axis VA of the electronic circuit, a conductor 14 (also referred to as a signal trace), a via structure 16 extending along the vertical axis between at least two of the two or more layers, and an absorber sheet termination 18. The absorber sheet termination 18 is used in conjunction with the electronic circuit assembly 10 to terminate RF and microwave signals of the electronic circuit, as will be explained in further detail below. It will be apparent to a person of ordinary skill in the art that the absorber sheet termination 18 may be used to terminate signal(s) in other electronic circuit configurations without departing from the scope of the present disclosure.

In an exemplary embodiment, the conductor 14 is included as one of the layers 12 of the electronic circuit assembly 10. In the illustrated embodiment, the electronic circuit assembly 10 comprises four layers 12A, 12B, 12C, and 14 spaced apart vertically along the vertical axis VA of the electronic circuit. Furthermore, the layers 12A, 12B, 12C extend along a longitudinal axis LA of the electronic circuit assembly 10. The electronic circuit assembly 10 comprises a first end portion 20 and a second end portion 22 spaced apart along the longitudinal axis LA. In an exemplary embodiment, the conductor 14 comprises a stripline trace. Particularly, in the illustrated embodiment, the conductor 14 is a stripline trace between layer 12C and layer 12B. Moreover, the via structure 16 ends conductor 14 at the second end portion 22 of the electronic circuit assembly 10, and extends along the vertical axis VA between the layers 12A, 12B, 12C. The via structure 16 defines a signal path between the layers 12A, 12B,12C, however the via structure 16 is configured to contact the conductor 14 and not contact conductors of other layers.

The absorber sheet termination 18 comprises an absorber sheet formed of one or more absorber materials comprising electromagnetic characteristics such that the absorber sheet is configured to absorb and dissipate electromagnetic energy efficiently. When the absorber sheet contacts at least a portion of the via structure 16, the absorber sheet is configured to absorb a signal traveling along the signal path defined by the via structure. The absorber sheet is configured to absorb signals such as RF and microwave signals to terminate the signals. In one example, the absorber sheet comprises a foam-like sheet formed of one or more absorber materials with an attenuation in an inclusive range from 22 dB/cm to 26 dB/cm at 3 GHz. However, other absorber sheet materials may be selected based on the operating conditions of the electronic circuit assembly 10.

Advantageously, installing the absorber sheet termination 18 on the electronic circuit assembly 10 to terminate a signal does not require soldering, and furthermore uninstalling the absorber sheet termination does not require desoldering. Instead, the absorber sheet termination 18 is installed by covering a component of the electronic circuit assembly 10 used to transport signal such as the via structure 16 with the absorber sheet to terminate the signal traveling there through. Accordingly, the absorber sheet termination 18 minimizes reflections, reduces interference, and maintains signal integrity associated with the electronic circuit assembly 10. Furthermore, by using the absorber sheet termination 18, crosstalk associated with the electronic circuit assembly 10 may be more accurately measured by a crosstalk measurement device of the electronic circuit.

Testing of the absorber sheet termination 18 in accordance with the present disclosure has revealed that the absorber sheet serves as an effective termination solution, effectively working from 1 GHz and extending to at least 30 GHz. In the testing, a return loss measurement of a stripline trace that ended with a via structure was evaluated using a vector network analyzer. Particularly, the stripline trace was evaluated when it was loaded with an absorber sheet and when it was unloaded. Furthermore, the findings indicate that broadband termination represented by the return loss measurement can be achieved with proper setup including factors such as a size of material used for the absorber sheet and an amount of pressure applied when covering the via structure with the absorber sheet.

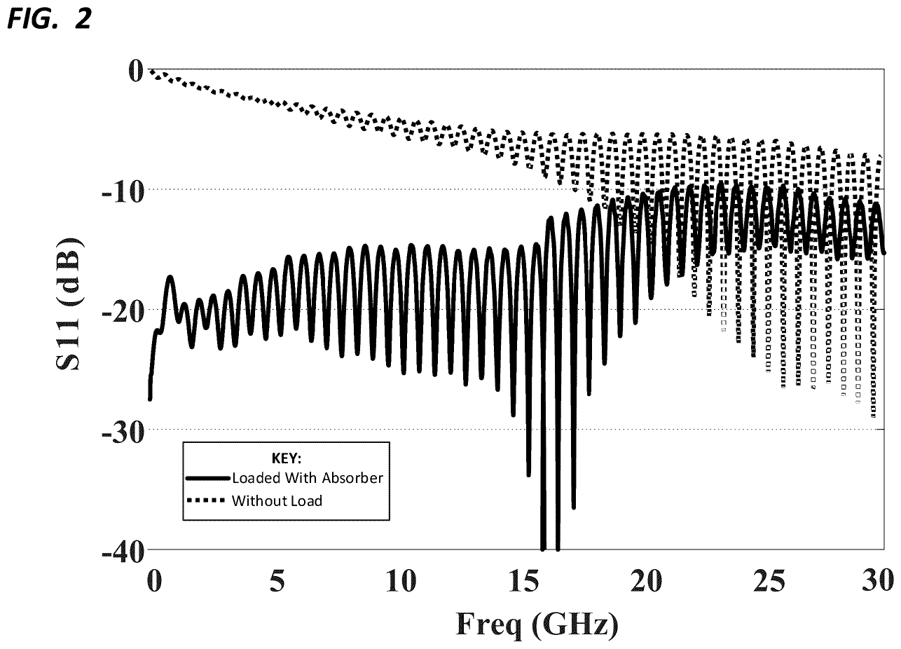

In the graph of FIG. 2, measurement of return loss (dB) with and without the absorber sheet is shown. As the graph indicates, the absorber sheet performs as a good termination and the return loss is better than 10 dB in a wide frequency range.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products without departing from the scope of the invention, it is intended that all matter contained in the above description and shown in the accompanying drawings shall be interpreted as illustrative and not in a limiting sense.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. An electronic circuit assembly comprising:
a plurality of layers, the layers including an upper layer and one or more lower layers spaced apart from the upper layer along a vertical axis of the electronic circuit assembly;
a conductor between the upper layer and at least one of the lower layers;
a via structure extending along the vertical axis between the upper layer and the at least one of the lower layers and configured to contact the conductor to define a signal path between the layers; and
a termination on the via structure, the termination comprising an absorber sheet contacting the via structure on the upper layer, wherein the absorber sheet is configured to absorb a signal traveling along the signal path when the absorber sheet contacts the via structure and the conductor.

2. The electronic circuit assembly of claim 1, wherein the conductor comprises a stripline trace.

3. The electronic circuit assembly of claim 1, wherein the absorber sheet is formed of absorber materials and configured to terminate the via structure in a microwave frequency range.

4. The electronic circuit assembly of claim 1, further comprising a plurality of conductors between the layers of the electronic circuit assembly.

5. The electronic circuit assembly of claim 1, wherein the absorber sheet is formed of one or more absorber materials having an attenuation in an inclusive range from 22 dB/cm to 26 dB/cm at 3 Ghz.

6. The electronic circuit assembly of claim 1, wherein the absorber sheet comprises a foam-like sheet.

7. The electronic circuit assembly of claim 1, wherein the absorber sheet comprises a single piece of monolithic absorber sheet material.

8. The electronic circuit assembly of claim 1, wherein the electronic circuit assembly comprises a high frequency electronic circuit.

9. The electronic circuit assembly of claim 1, further comprising a crosstalk measurement device configured to measure crosstalk of the electronic circuit assembly.

10. A termination for terminating an electromagnetic signal traveling along a signal path of an electronic circuit, the termination comprising an absorber sheet configured to contact at least a portion of the signal path to be terminated, the absorber sheet comprising one or more absorber materials configured to absorb the electromagnetic signal when the absorber sheet contacts the portion of the signal path.

11. The termination of claim 10, wherein the one or more absorber materials comprise an attenuation in an inclusive range from 22 dB/cm to 26 dB/cm at 3 Ghz.

12. The termination of claim 10, wherein the absorber sheet comprises a single piece of monolithic absorber sheet material.

13. The termination of claim 12, wherein the absorber sheet is configured to contact a plurality of signal paths of the electronic circuit to terminate one or more electromagnetic signals traveling along the plurality of signal paths.

14. The termination of claim 10, wherein the absorber sheet is configured to absorb at least one of a microwave frequency signal or a radiowave frequency signal.

15. A method for terminating an electromagnetic signal in an electronic circuit assembly, the method comprising:
covering a via structure in the electronic circuit assembly with an absorber sheet; and
applying pressure to the absorber sheet to create a contact from the absorber sheet to the via structure such that the absorber sheet absorbs the electromagnetic signal thereby terminating the electromagnetic signal;
wherein terminating the electromagnetic signal does not include at least one of soldering or screwing an electrical load to the electronic circuit assembly.

16. The method of claim 15, wherein the electromagnetic signal comprises at least one of a microwave frequency signal or a radiowave frequency signal.

17. The method of claim 15, further comprising assembling the electronic circuit assembly, wherein the electronic circuit assembly includes:
a plurality of layers, the layers including an upper layer and one or more lower layers spaced apart from the upper layer along a vertical axis of the electronic circuit assembly;
a conductor between the upper layer and at least one of the lower layers; and
the via structure, wherein the via structure extends along the vertical axis between the upper layer and the at least one of the lower layers and is configured to contact the conductor, and wherein the via structure and the conductor define a signal path between the layers.

18. The method of claim 15, further comprising covering an additional via structure in the electronic circuit assembly with the absorber sheet and applying pressure to the absorber sheet to create a contact from the absorber sheet to the additional via structure such that the absorber sheet absorbs an electromagnetic signal associated with the additional via structure.

19. The method of claim 15, wherein the absorber sheet comprises a foam-like sheet.

20. The method of claim 15, wherein the absorber sheet is formed of one or more absorber materials having an attenuation in an inclusive range from 22 dB/cm to 26 dB/cm at 3 Ghz.
